(19) United States
(12) Patent Application Publication
(10) Pub. No.: US 2022/0191235 A1
(43) Pub. Date: Jun. 16, 2022

(54) SYSTEMS AND METHODS FOR IMPROVING SECURITY

(71) Applicant: BEIJING DIDI INFINITY TECHNOLOGY AND DEVELOPMENT CO., LTD., BEIJING (CN)

(72) Inventors: Zetian NI, Mountain View, CA (US); Zihan YI, Mountain View, CA (US); Kaidan YANG, Beijing (CN); Xin CHEN, Mountain View, CA (US)

(73) Assignee: BEIJING DIDI INFINITY TECHNOLOGY AND DEVELOPMENT CO., LTD., BEIJING (CN)

(21) Appl. No.: 17/644,336

(22) Filed: Dec. 14, 2021

Related U.S. Application Data
(63) Continuation of application No. PCT/CN2020/135924, filed on Dec. 11, 2020.

(51) Int. Cl. H04L 9/40; G06F 16/9535; G06N 20/00

(52) U.S. Cl. CPC H04L 63/1433; H04L 63/20; G06N 20/00; H04L 63/1416; G06F 16/9535

(57) ABSTRACT

The present disclosure provides a system for improving security. The system may identify a query associated with a user account, and access an ID graph database to obtain an ID graph relating to the user account by a database driver. The system may also determine whether the user account is a target account type based at least on the ID graph. The ID graph may include a plurality of nodes and a plurality of edges. Each of the plurality of edges may connect two nodes. Each of the plurality of nodes may include at least one of a register ID, a login ID, a payment ID, a background check ID, or a face ID. Each edge that connects two nodes may include at least one of a user type associated with the two nodes, a timestamp when the edge is connected, or source information of the edge.

### CROSS-REFECRENCE TO RELATED APPLICATIONS

This application is a continuation of International Application No. PCT/CN2020/135924, filed on Dec. 11, 2020, the contents of which are incorporated herein in its entirety by reference.

### TECHNICAL FIELD

The present disclosure generally relates to improving security of a service, and in particular, to systems and methods for identifying users with duplicate accounts and/or users with potential security threats.

### BACKGROUND

Safety is a top priority for all kinds of online-to-offline services, such as but not limited to transportation services. Managers of online transportation service platforms often endeavor to improve safety for the users (e.g., passengers and drivers) of the platform. Historical data of users of such platforms demonstrates that the majority of crimes associated with the transportation services are committed by repeat offenders. Therefore, to improve the security of the transportation service, it would be helpful to restrict the access of repeat offenders to such service. One common approach employed by a prior offender to regain access to a service is to create a new account, when his/her original account is disabled or blocked. Therefore, to improve security, and with other possible applications, it is desirable to provide effective systems and methods for identifying users with duplicate accounts and/or users with potential security threats.

### SUMMARY

According to one aspect of the present disclosure, a system is provided. The system may include at least one storage medium including a set of instruction and at least one processor in communication with the storage medium. When executing the set of instructions, the at least one processor may be directed to cause the system to perform the following operations. The at least one processor may be directed to cause the system to identify a query associated with a user account, and access an ID graph database to obtain an ID graph relating to the user account by a database driver. The at least one processor may also be directed to cause the system to determine whether the user account is a target account type based at least on the ID graph. The ID graph may include a plurality of nodes and a plurality of edges. Each of the plurality of edges may connect two nodes. Each of the plurality of nodes may include at least one of a register ID, a login ID, a payment ID, a background check ID, or a face ID. Each edge that connects two nodes may include at least one of a user type associated with the two nodes, a timestamp when the edge is connected, or source information of the edge.

In some embodiments, the query may be triggered by a bubbling event associated with the user account, an order stream associated with the user account, a registration of the user account, a login of the user account, or a query request initiated by an operator.

In some embodiments, the ID graph database may include an Hbase.

In some embodiments, the target account type may be a duplicate account, and the determining whether the user account is the target account type based at least on the ID graph may include determining whether the user account connects to one or more second user accounts via at least one common node based on the ID graph, and in response to a determination that the user account connects to the one or more second user accounts via the at least one common node, determining the user account is the duplicate account of the one or more second user accounts.

In some embodiments, the target account type may be associated with a potential security threat. The determining whether the user account is the target account type based at least on the ID graph may include obtaining user behavior record associated with the user account and user information associated with the user account, and determining whether the user account is associated with the potential security threat based on the ID graph, the user behavior record, and the user information.

In some embodiments, the determining whether the user account is associated with the potential security threat based on the ID graph, the behavior record, and the user information may include obtaining a trained machine learning model, and determining whether the user account is associated with the potential security threat based on the trained machine learning model, the ID graph, the user behavior record, and the user information.

In some embodiments, the determining whether the user account is associated with the potential security threat based on the trained machine learning model, the ID graph, the user behavior record, and the user information may include obtaining a risk score representing a probability that the user account has the potential security threat by inputting the ID graph, the user behavior record, and the user information into the trained machine learning model, and determining whether the user account is associated with the potential security threat based on the risk score. The risk score may be an output of the trained machine learning model. The risk score may be greater than a score threshold indicates that the user account is associated with the potential security threat.

In some embodiments, the at least one processor may be directed to cause the system to determine an account management strategy based on a rule of strategies and the risk score, and implement the account management strategy on the user account. The strategy may include at least one of maintaining the user account, banning the user account, inviting a user of the user account to provide more information, or silencing the user account.

In some embodiments, the at least one processor may be directed to cause the system to identify a third user account connected with the user account within a hoop threshold, and determine that the third user account is associated with the potential security threat.

In some embodiments, each of the plurality of nodes of the ID graph may comprise a confidence weight representing a confidence that the node contributes a determination that the user account is the target account type.

In some embodiments, different nodes representing different IDs that comprise different confidence weights, and the face ID may comprise a greater confidence weight than any other nodes.

According to another aspect of the present disclosure, a method is provided. The method may include identifying a query associated with a user account and accessing an ID graph database to obtain an ID graph relating to the user account by a database driver. The method may include determining whether the user account is a target account type based at least on the ID graph. The ID graph may include a plurality of nodes and a plurality of edges. Each of the plurality of edges may connect two nodes. Each of the plurality of nodes may include at least one of a register ID, a login ID, a payment ID, a background check ID, or a face ID. Each edge that connects two nodes may include at least one of a user type associated with the two nodes, a timestamp when the edge is connected, or source information of the edge.

According to still another aspect of the present disclosure, a non-transitory computer readable medium including at least one set of instructions is provided. When accessed by at least one processor of a system for improving security, the at least one set of instructions may cause the system to execute a method. The method may include identifying a query associated with a user account and accessing an ID graph database to obtain an ID graph relating to the user account by a database driver. The method may include determining whether the user account is a target account type based at least on the ID graph. The ID graph may include a plurality of nodes and a plurality of edges. Each of the plurality of edges may connect two nodes. Each of the plurality of nodes may include at least one of a register ID, a login ID, a payment ID, a background check ID, or a face ID. Each edge that connects two nodes may include at least one of a user type associated with the two nodes, a timestamp when the edge is connected, or source information of the edge.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary system of an online to offline service according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing device according to some embodiments of the present disclosure;

FIG. 5 is a flowchart illustrating an exemplary process for determining whether a user account is a target account type according to some embodiments of the present disclosure;

FIG. 6 is a schematic diagram illustrating an exemplary system for generating and accessing an identity (ID) graph database according to some embodiments of the present disclosure;

FIG. 7 is a schematic diagram illustrating an exemplary ID graph engine according to some embodiments of the present disclosure;

FIG. 8 is a schematic diagram illustrating an exemplary user interface according to some embodiments of the present disclosure;

FIG. 9 is a flowchart illustrating an exemplary process for determining whether a user account is a duplicate account according to some embodiments of the present disclosure;

FIG. 10 is a flowchart illustrating a process for determining whether a user account is associated with a potential security threat according to some embodiments of the present disclosure; and

FIG. 11 is a schematic diagram illustrating an exemplary system for determining whether a user account is associated with a potential security threat according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to some embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood that the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for identifying whether a user account is a target account type. The target account type may refer to a duplicate account, a user account associated with a potential security threat, etc. In some embodiments, the systems and methods of the present disclosure use ID information (e.g., a register ID, a login ID, a payment ID, a background check ID, or a face ID, etc.) of users as nodes and relationships of two nodes as edges (e.g., a user type associated with the two nodes, a timestamp when an edge is connected, or source information of the edge, etc.) to establish ID graphs, and store the ID graphs into an ID graph database (e.g., an Hbase). The use of the ID graphs and the ID graph database enables the storage and querying of a large amount of data (big data) with good scalability and distributed computation. Furthermore, the graph structure of the ID graph provides an effective tool to identify users with multiple accounts. Duplicate accounts, such as user accounts share common ID information, may be clearly identifiable in the ID graphs. The ID graphs may further be used to determine whether the user account is associated with a potential security threat together with a trained model, historical behavior information of the user account, and the basic information of the user account. In this way, duplicate accounts and/or user accounts associated with the potential security threat may be identified effectively, thereby improving security.

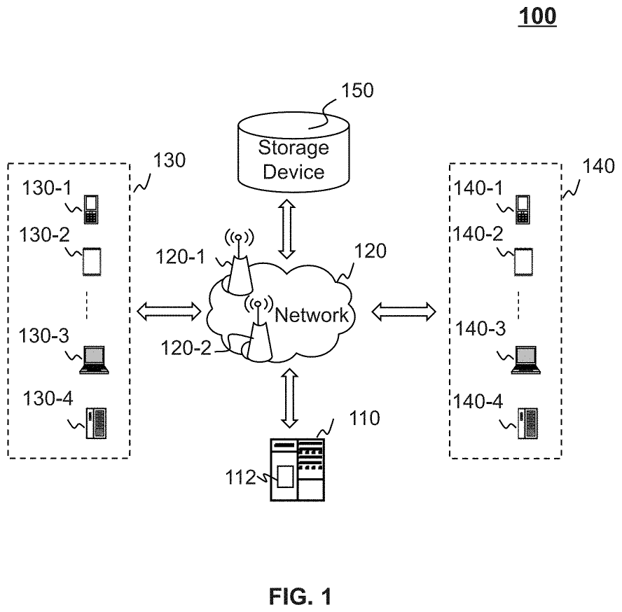

FIG. 1 is a block diagram of an exemplary system 100 of an online to offline service according to some embodiments of the present disclosure. For example, the system 100 may be an online transportation service platform for transportation services such as taxi hailing service, chauffeur service, express car service, carpool service, vehicle schedule service, bus service, driver hire, and shuttle service. The system 100 may include a server 110, a network 120, a passenger terminal 130, a driver terminal 140, and a storage device 150. The server 110 may include a processing device 112.

During operation, one or more components of the system 100, such as the passenger terminal 130, the driver terminal 140, the storage 150, other component of the server 110, may install an application configured to communicate (e.g., via wired or wireless communication) and operate the methods disclosed in the present disclosure, such as sending requests to identify a query associated with a user account to the server 110. For example, through the application, a user may input some query terms (e.g., a user ID, a max depth, a count of max nodes) through his/her computer and wish to acquire an ID graph corresponding to the query terms.

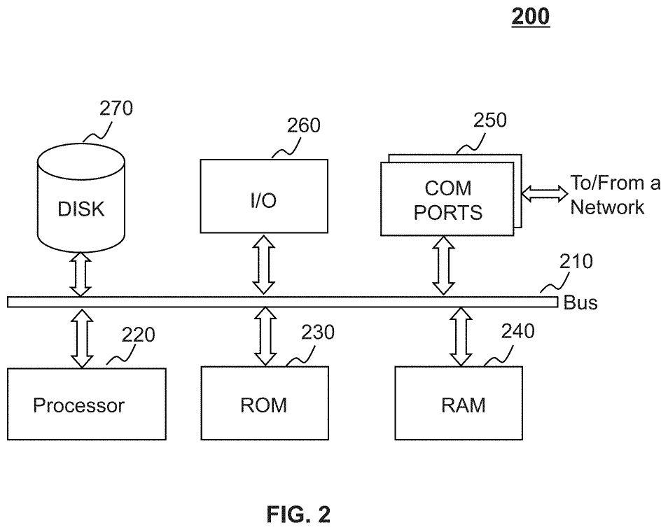

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the passenger terminal 130, the driver terminal 140, and/or the storage device 150 via the network 120. As another example, the server 110 may be directly connected to the passenger terminal 130, the driver terminal 140, and/or the storage device 150 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing device 112. The processing device 112 may process information and/or data relating to the service request to perform one or more functions of the server 110 described in the present disclosure. For example, the processing device 112 may identify a query associated with a user account. As another example, the processing device 112 may access an ID graph database (e.g., an Hbase) by a database driver to obtain an ID graph relating to the user account. As still another example, the processing device 112 may determine whether the user account is a target account type based at least on the ID graph. In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the passenger terminal 130, the driver terminal 140, and/or the storage device 150) may transmit information and/or data to other component(s) in the system 100 via the network 120. For example, the server 110 may obtain/acquire service request data from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra-wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the system 100 may be connected to the network 120 to exchange data and/or information.

The passenger terminal 130 may be used by a passenger to request an online to offline service. The online to offline service may include an on-demand transportation service. For example, a user of the passenger terminal 130 may use the passenger terminal 130 to transmit a service request for himself/herself or another user, or receive service and/or information or instructions from the server 110. The driver terminal 140 may be used by a driver to reply an online to offline service. For example, a user of the driver terminal 140 may use the driver terminal 140 to receive a service request from the passenger terminal 130, and/or information or instructions from the server 110. In some embodiments, the term “user” and “passenger terminal” may be used interchangeably, and the term “user” and the “driver terminal” may be used interchangeably.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, built-in device in the motor vehicle 130-4 may include an onboard computer, an onboard television, etc. In some embodiments, the passenger terminal 130 may be a wireless device with positioning technology for locating the position of the user and/or the passenger terminal 130.

In some embodiments, the driver terminal 140 may include a mobile device 140-1, a tablet computer 140-2, a laptop computer 140-3, a built-in device in a motor vehicle 140-4, or the like, or any combination thereof. In some embodiments, the mobile device 140-1 may include a smart home device, a wearable device, a smart mobile device, a virtual reality device, an augmented reality device, or the like, or any combination thereof. In some embodiments, the driver terminal 140 may be similar to, or the same device as the passenger terminal 130. In some embodiments, the driver terminal 140 may be a wireless device with positioning technology for locating the position of the driver and/or the driver terminal 140. In some embodiments, the passenger terminal 130 and/or the driver terminal 140 may communicate with other positioning device to determine the position of the passenger, the passenger terminal 130, the driver, and/or the driver terminal 140. In some embodiments, the passenger terminal 130 and/or the driver terminal 140 may transmit positioning information to the server 110.

The storage device 150 may store data and/or instructions. In some embodiments, the storage device 150 may store data obtained/acquired from the passenger terminal 130 and/or the driver terminal 140. In some embodiments, the storage device 150 may store data and/or instructions that the server 110 may execute or use to perform exemplary methods described in the present disclosure. In some embodiments, the storage device 150 may include a mass storage device, a removable storage device, a volatile read-and-write memory, a read-only memory (ROM), or the like, or any combination thereof. Exemplary mass storage device may include a magnetic disk, an optical disk, a solid-state drive, etc. Exemplary removable storage device may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the 100 (e.g., the server 110, the passenger terminal 130, the driver terminal 140, etc.). One or more components in the system 100 may access the data or instructions stored in the storage device 150 via the network 120. In some embodiments, the storage device 150 may be directly connected to or communicate with one or more components in the system 100 (e.g., the server 110, the passenger terminal 130, the driver terminal 140, etc.). In some embodiments, the storage device 150 may be part of the server 110.

In some embodiments, one or more components in the system 100 (e.g., the server 110, the passenger terminal 130, the driver terminal 140, etc.) may have a permission to access the storage device 150. In some embodiments, one or more components in the system 100 may read and/or modify information related to the passenger, driver, and/or the public when one or more conditions are met. For example, the server 110 may read and/or modify one or more users' information after a service. As another example, the driver terminal 140 may access information related to the passenger when receiving a service request from the passenger terminal 130, but the driver terminal 140 may not modify the relevant information of the passenger.

In some embodiments, information exchanging of one or more components in the system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the system 100 performs, the element may perform through electrical signals and/or electromagnetic signals. For example, when a passenger terminal 130 processes a task, the passenger terminal 130 may operate logic circuits in its processor to perform such task. When the passenger terminal 130 transmits out a service request to the server 110, a processor of the server 110 may generate electrical signals encoding the request. The processor of the server 110 may then transmit the electrical signals to an output port. If the passenger terminal 130 communicates with the server 110 via a wired network, the output port may be physically connected to a cable, which further transmit the electrical signal to an input port of the server 110. If the passenger terminal 130 communicates with the server 110 via a wireless network, the output port of the service requester terminal 130 may be one or more antennas, which convert the electrical signal to electromagnetic signal. Similarly, a driver terminal 140 may process a task through operation of logic circuits in its processor, and receive an instruction and/or service request from the server 110 via electrical signal or electromagnet signals. Within an electronic device, such as the passenger terminal 130, the driver terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 according to some embodiments of the present disclosure. The computing device 200 may be used to implement any component of the system 100 as described herein. For example, the user terminal 130 and/or the processing device 112 may be implemented on the computing device 200, respectively, via its hardware, software program, firmware, or a combination thereof. Although only one such computing device is shown, for convenience, the computer functions relating to the system 100 as described herein may be implemented in a distributed fashion on a number of similar platforms, to distribute the processing load.

As illustrated in FIG. 2, the computing device 200 may include a communication bus 210, a processor 220, a storage device, an input/output (I/O) 260, and a communication port 250. The processor 220 may execute computer instructions (e.g., program code) and perform functions of one or more components of the system 100 (e.g., the server 110) in accordance with techniques described herein. The computer instructions may include, for example, routines, programs, objects, components, data structures, procedures, modules, and functions, which perform particular functions described herein. In some embodiments, the processor 220 may include interface circuits and processing circuits therein. The interface circuits may be configured to receive electronic signals from the communication bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the communication bus 210.

In some embodiments, the processor 220 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor 220 is described in the computing device 200. However, it should be noted that the computing device 200 in the present disclosure may also include multiple processors, thus operations and/or method operations that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage device may store data/information related to the system 100. In some embodiments, the storage device may include a mass storage device, a removable storage device, a volatile read-and-write memory, a random access memory (RAM) 240, a read-only memory (ROM) 230, a disk 270, or the like, or any combination thereof. In some embodiments, the storage device may store one or more programs and/or instructions to perform exemplary methods described in the present disclosure. For example, the storage device may store a program for the processor 220 to execute.

The I/O 260 may input and/or output signals, data, information, etc. In some embodiments, the I/O 260 may enable a user interaction with the computing device 200. In some embodiments, the I/O 260 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 250 may be connected to a network (e.g., the network 120) to facilitate data communications. The communication port 250 may establish connections between the computing device 200 and one or more components of the system 100. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 250 may be and/or include a standardized communication port, such as RS232, RS485, etc. In some embodiments, the communication port 250 may be a specially designed communication port.

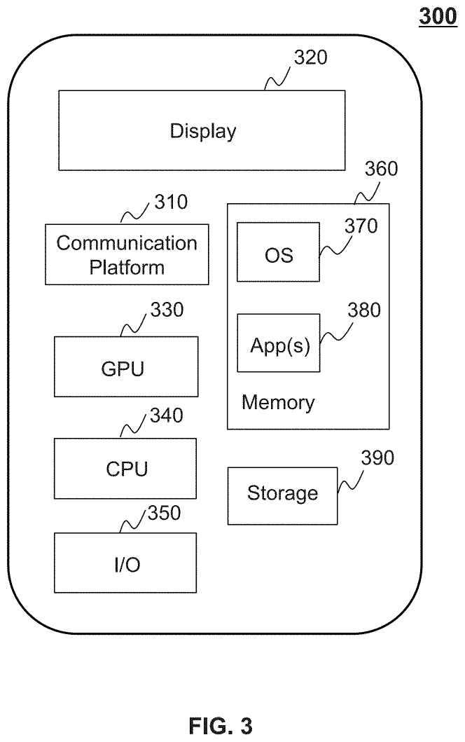

FIG. 3 is a schematic diagram illustrating exemplary hardware and/or software components of a mobile device 300 according to some embodiments of the present disclosure. In some embodiments, one or more components of the system 100, such as the user terminal 130 and/or the processing device 112 may be implemented on the mobile device 300. As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the system 100. User interactions with the information stream may be achieved via the I/O 350 and provided to one or more other components of the system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

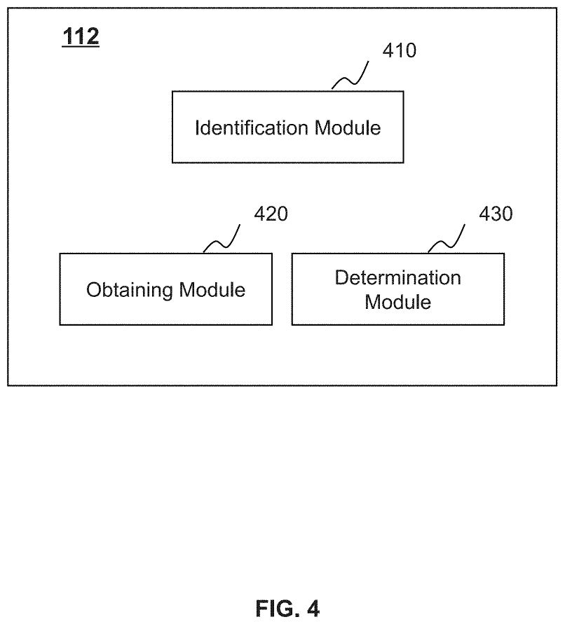

FIG. 4 is a block diagram illustrating an exemplary processing device 112 according to some embodiments of the present disclosure. As shown in FIG. 4, the processing device 112 may include an identification module 410, an obtaining module 420, and a determination module 460.

The identification module 410 may be configured to identify a query associated with a user account. The term “user account” may refer to any mechanism and/or information of a user, provided to the system 100 by the user or by a third party, to identify or authenticate the user to the system 100 for the purposes of using products or services of the system 100. For example, the user account may include a register ID, a login ID, a payment ID, a background check ID, a biometric ID, or the like, or any combination thereof. The query may be a request for identifying the user account. In some embodiments, the query may be triggered by a trigger event and/or a query request initiated by an operator. The identification module 410 may identify the trigger event in real-time or for each of a predetermined time interval. More descriptions regarding the identification of the query may be found elsewhere in the present disclosure. See, e.g., 510 and relevant descriptions thereof.

The obtaining module 420 may be configured to access an ID graph database by a database driver to obtain an ID graph relating to the user account. The ID graph database may refer to a database that stores and manages graph structures that can be used to represent information of a plurality of user accounts and the relationships of the accounts (as well as the information thereof). The ID graph database may include a plurality of ID graphs, each of which may include a graph structure including nodes and edges. In some embodiments, the ID graph database may include an Hbase. The database driver may be a computer program or software that communicates with the ID graph database to access the ID graph database and/or transform information to an underlying data structure of the ID graph database. More descriptions regarding the access of the ID graph database may be found elsewhere in the present disclosure. See, e.g., 520 and relevant descriptions thereof.

The determination module 460 may be configured to determine whether the user account is a target account type based at least on the ID graph. In some embodiments, the target account type may be a duplicate account, an account type associated with a certain event, or the like, or any combination thereof. In some embodiments, the determination module 460 may determine whether the user account is the target account type based on nodes and edges of the ID graph. For example, the determination module 460 may determine whether the user account is the duplicate account by determining whether the user account connects to one or more second user accounts via at least one common node based on the ID graph. In some embodiments, the determination module 460 may determine whether the user account is associated with a potential security threat based on the ID graph and any information relating to the user account (e.g., a user behavior record associated with the user account, user information of the user account, etc.). For example, the determination module 460 may determine whether the user account is associated with a potential security threat based on a trained machine learning model, the ID graph, user behaviors, and user information. More descriptions regarding the determination as to whether the user account is a target account type may be found elsewhere in the present disclosure. See, e.g., 530 and relevant descriptions thereof.

The modules may be hardware circuits of all or part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions. The modules in the processing device 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units.

It should be noted that the above descriptions of the processing devices 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more of the modules mentioned above may be omitted. In some embodiments, one or more of the modules mentioned above may be combined into a single module. In some embodiments, the processing device 112 may further include one or more additional modules, such as a storage module.

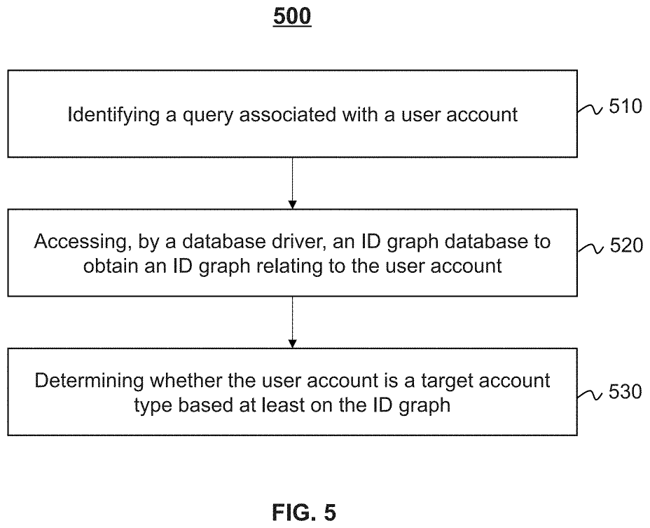

FIG. 5 is a flowchart illustrating an exemplary process 500 for determining whether a user account is a target account type according to some embodiments of the present disclosure. In some embodiments, the process 500 may be executed by the system 100. For example, the process 500 may be implemented as a set of instructions (e.g., an application) stored in a storage device (e.g., the storage device 140, the ROM 230, the RAM 240, the storage 390). In some embodiments, the processing device 112 (e.g., the processor 220 of the computing device 200, the CPU 340 of the mobile device 300, and/or one or more modules illustrated in FIG. 4) may execute the set of instructions and may accordingly be directed to perform the process 500.

In 510, the processing device 112 (e.g., the identification module 410, the processing circuits of the processor 220) may identify a query associated with a user account.

The term “user account” as used herein, may refer to any mechanism and/or information of a user, provided to the system 100 by the user or by a third party, to identify or authenticate the user to the system 100 for the purposes of using products or services of the system 100. In some embodiments, the user account may include any information of the user. For example, the user account may include a register ID, a login ID, a payment ID, a background check ID, a biometric ID, or the like, or any combination thereof. In some embodiments, the register ID may be register information that the user uses to register a new user account of the system 100. For example, the register ID may include a name, a phone number, an e-mail ID, a social media ID (e.g., a LinkedIn™ account, a Facebook® account, a WeChat™ number, etc.), an ID number, a driver license ID, a car plate ID of the user, or the like, or any combination thereof. In some embodiments, the login ID may be login information that the user uses to login to the system 100. For example, the login ID may include the register information, a device ID, an IP address, or the like, or any combination thereof. In some embodiments, the payment ID may include payment information that the user uses to pay for the system 100. For example, the payment ID may include a credit card ID, a PayPal ID, a bank account, an eBay ID, or the like, or any combination thereof. In some embodiments, the background check ID may be information that is used for a background check. For example, the background check ID may include a national ID, a social media ID (e.g., a LinkedIn™ account, a Facebook® account, a WeChat™ number, etc.), or the like, or any combination thereof. In some embodiments, the biometric ID may be biometric information of the user. For example, the biometric ID may include a face ID, an iris ID, a fingerprint ID, a voice ID, a signature ID, or the like, or any combination thereof.

In some embodiments, the query may be a request for identifying the user account. For example, the query may include a request for obtaining an ID graph relating to the user account, a request for determining whether the user account is a target account type, a request for determining a type of the user account, or the like, or any combination thereof. In some embodiments, the query may be automatically triggered when a trigger event occurs. For example, the trigger event may include a bubbling event associated with the user account, an order stream associated with the user account, a registration of the user account, a login of the user account, or the like, or any combination thereof. In some embodiments, the bubbling event associated with the user account may indicate that the user of the user account logs in to the system 100 (e.g., an application of the system 100), browses, and/or searches information without placing an order from the system 100. For example, in a transportation system providing car-hailing services, the bubbling event associated with the user account may be a user's searching for a destination and browsing information relating to the searching of the destination, but without placing a car-hailing order yet. As another example, in an online shopping system, the bubbling event associated with the user account may be a user's searching for goods and browsing information relating to the goods, but without placing a purchase order of the goods yet. In some embodiments, the order stream associated with the user account may refer to any order placed using the user account. For example, the order stream may include an order that the user account initiates, an order that the user account receives, an order that the user account executes, or the like, or any combination thereof. In some embodiments, the registration of the user account may be a registration request initiated by a user for creating the user account. In some embodiments, the query may be triggered by a query request initiated by an operator (e.g., a customer service agent, a data analyst, a developer, etc.) of the system 100. In some embodiments, the query request may include a request for obtaining an ID graph of the user account, a request for determining a type of the user account, a request for determining whether the user account is a target account type, or the like, or any combination thereof.

In some embodiments, the processing device 112 may identify the trigger event in real-time. Once the trigger event occurs, the processing device 112 may automatically generate the query associated with the user account. In some embodiments, the processing device 112 may generate the query after obtaining a query request from an operator. For example, the operator may send the query request for obtaining an ID graph of the user account to be displayed on a user interface of a terminal of the operator to the processing device 112, thereby the processing device 112 may generate the query. In some embodiments, the processing device 112 may generate a query for each of a predetermined time interval. The predetermined time interval may be an hour, 6 hours, 12 hours, a day, a week, a month, etc. For example, the processing device 112 may generate a query every week.

In 520, the processing device 112 (e.g., the obtaining module 420, the processing circuits of the processor 220) may access an ID graph database by a database driver to obtain an ID graph relating to the user account.

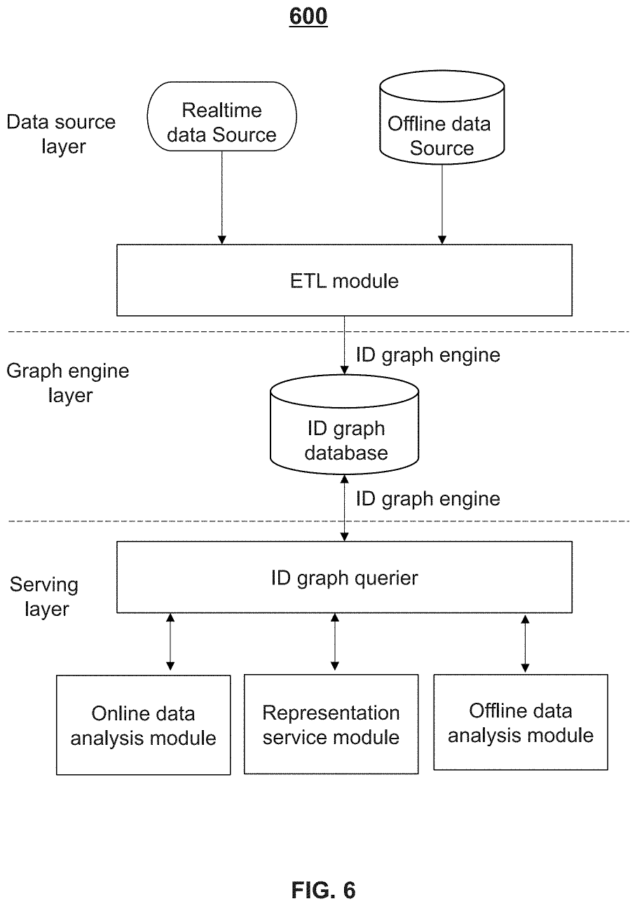

In some embodiments, the ID graph database may refer to a database that stores and manages graph structures that can be used to represent information of a plurality of user accounts and the relationships of the accounts (as well as the information thereof). For example, the ID graph database may include a plurality of ID graphs. In some embodiments, an ID graph of the plurality of ID graphs may include a graph structure including nodes and edges. The nodes may be used to represent the information of the corresponding user account and an edge connecting two nodes may be used to represent the relationship between the two nodes. In some embodiments, the ID graph database may be any graph database that meets specific requirements such as being suitable for a big data source and having scalability. For example, the ID graph database may include an Hbase, a DataStax Enterprise Graph database, an InfiniteGraph database, a JanusGraph database, a Sqrrl Enterprise database, or the like, or the like, or any combination thereof. Merely by way of example, the ID graph database may include an Hbase. The Hbase is a column-oriented database and tables therein are sorted by row. The Hbase is a distributed non-relational database that almost has infinite scalability and supports indexing. An exemplary process for generating and accessing the ID graph databased may be found elsewhere (e.g., FIG. 6 and the descriptions thereof) in the present disclosure.

In some embodiments, the database driver may be a computer program or software that communicates with the ID graph database to access the ID graph database and/or transform information to an underlying data structure of the ID graph database. In some embodiments, the underlying data structure of the ID graph database may be a data structure that is used to store the information of the plurality of user accounts in the ID graph database. In some embodiments, the underlining data structure may include a node, a linked list, an array, or the like, or any combination thereof. For example, the ID graph database is an Hbase and the databased driver is an Hbase driver (e.g., an Hbase client). The underlining data structure of the ID graph database may include an HBase data structure, such as a row key, a column family, a column qualifier, a value in bytes, or the like, or any combination thereof.

In some embodiments, the ID graph relating to the user account may represent information of the user account and one or more relevant user accounts of the user account using a graph structure. The one or more relevant user accounts may include common information (e.g., using a same phone number, a same e-mail ID, a same device ID, a same credit card ID, a same PayPal ID, a same national ID, a same Facebook® ID, etc.) with the user account. In some embodiments, the user account and the one or more relevant user accounts may correspond to a same ID graph. For example, if a user account B and a user account C use a same credit card ID to pay for an order, an ID graph relating to the user account B may be the same with an ID graph relating to a user account C.

In some embodiments, the ID graph relating to the user account may be a graph structure including a plurality of nodes and a plurality of edges. In some embodiments, a node of the plurality of nodes may represent an attribute or a user behavior of the user account and/or the one or more relevant user accounts. For example, the node may represent background check information associated with the user account, data mining information associated with the user account, user behavior information associated with the user account, order history information of the user account, incident history information of the user account, or the like, or any combination thereof. In some embodiments, the background check information may include a national ID, a Facebook® ID, a criminal history, a sentence, a sex offender history, a terror watchlist, a social security number (SSN) validation, etc., of the user account. In some embodiments, the data mining information may be any information extracted from the user information and/or the user behavior. For example, the data mining information may include an income score representing an income level of a user of the user terminal, a comment hunter, name2gender data, or the like. In some embodiments, the comment hunter may refer to a comment on the user account and is analyzed with a natural language processing (NLP) algorithm to identify whether the user account involves a potential security threat. The potential security threat may refer to a potential negative action or event that may result in a criminal event or a cheating. For example, if the comment hunter includes a comment indicating that the user account often offends drivers or passengers, the user account may be considered to have the potential security threat. In some embodiments, the name2gender data may include a prediction of a gender of the user of the user account using the name of the user. In some embodiments, the user behavior information associated with the user account may include a registration, a login, placing an ordering, canceling an order (e.g., after the last finished order, before a finished order, etc.), a bubbling event, a count of the canceling orders before a finished order, a count of the bubbling events, an occurrence time of the user behavior (e.g., the registration), or the like, or any combination thereof. According to research, a user that intends to commit a crime often cancels several orders until choosing a target driver or passenger, and/or registers a new user account. Thus, the count of the canceling orders before a finished order, the count of the bubbling events, and the occurrence time of the registration may reflect the probability of a potential security threat associated with the user account. Merely by way of example, the node may include a register ID, a login ID, a payment ID, a background check ID, a biometric ID (e.g., a face ID) of the user account. In some embodiments, each of the plurality of nodes of the ID graph may comprise a confidence weight representing a confidence that the node contributes a determination that the user account is the target account type. In some embodiments, different nodes representing different IDs may comprise different confidence weights. For example, the biometric ID (e.g., the face ID, the fingerprint ID) may comprise a greater confidence weight than any other nodes, since the biometric ID is specific and hard to fake.

In some embodiments, each of the plurality of edges may connect two nodes. An edge, which constitutes information, may connect two nodes and include a user type associated with the two nodes, a timestamp when the edge is connected, where the two nodes and/or the connection between the two nodes come from (e.g., source information of the two nodes and/or the edge), or the like, or any combination thereof. For example, the user type may include a passenger and a driver. The source information may include a source type (e.g., HIVE, KAFKA, DDMQ) of the edge, a source name (e.g., a table name, a message queue name) of the source type, a value (e.g., the timestamp), or the like, or any combination thereof. In some embodiments, each of the plurality of edges of the ID graph may comprise a confidence weight representing a confidence that the edge contributes a determination that the user account is the target account type. For example, an edge connecting a node of the biometric ID (e.g., the face ID, the fingerprint ID) may comprise a greater confidence weight than any other nodes. In some embodiments, the edges connecting different IDs may comprise different confidence weights. In some embodiments, each of the plurality of edges of the ID graph may comprise a confidence weight representing a similarity between the two nodes. For example, a confidence weight of an edge between two nodes of face IDs may be a similarity between the two face IDs. The higher the similarity, the greater the confidence weight.

In 530, the processing device 112 (e.g., the determination module 430, the processing circuits of the processor 220) may determine whether the user account is a target account type based at least on the ID graph.

In some embodiments, the target account type may be a duplicate account, an account type associated with a certain event, or the like, or any combination thereof. In some embodiments, the duplicate account may be one of multiple accounts of a same user. For example, the duplicate account may be one of two or more user accounts that are used by a same user for registration, login, or placing orders. In some embodiments, the account type associated with the certain event may refer to a user account that involves the certain event. For example, the certain event may include a commercial advertising and promotion, a potential security threat that may result in a criminal event, a malicious evaluation, or the like, or any combination thereof.

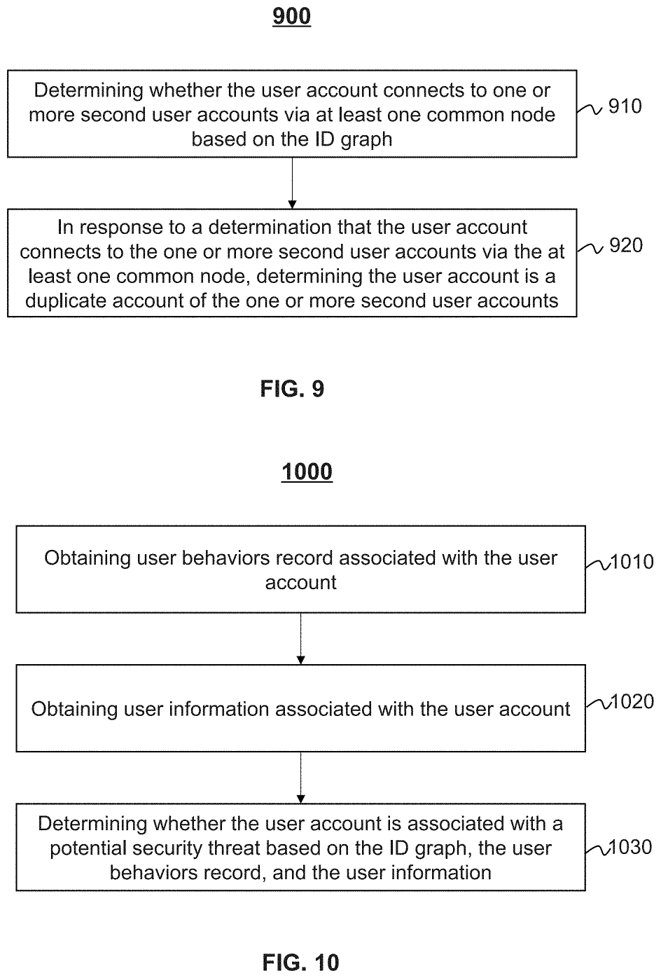

In some embodiments, the processing device 112 may determine whether the user account is the target account type based on nodes and edges of the ID graph. For example, the processing device 112 may determine whether the user account is a duplicate account by determining whether the ID graph of the user account has one or more common nodes with an ID graph of another user account. The one or more common nodes between the user account and a second user account may indicate that the user account is a duplicate account of the second user account or the second user account is a duplicate account of the user account. An exemplary process for determining whether the user account is a duplicate account may be found elsewhere (e.g., FIG. 9 and the descriptions thereof) in the present disclosure. In some embodiments, in response to a determination that the user account is the duplicate account, the processing device 122 may implement an account management strategy on the user account. For example, the processing device 122 may combine the user account and the second user account into a single user account, maintain the user account and/or the second user account, monitor the user account and/or the second user account, or the like, or any combination thereof.

In some embodiments, the processing device 112 may determine whether the user account is associated with a potential security threat based on the ID graph and any information relating to the user account (e.g., a user behavior record associated with the user account, user information of the user account, etc.). An exemplary process for determining whether the user account is associated with the potential security threat may be found elsewhere (e.g., FIG. 10 and the descriptions thereof) in the present disclosure. In some embodiments, in response to a determination that the user account is associated with the potential security threat, the processing device 122 may implement an account management strategy on the user account. For example, the processing device 122 may maintain the user account, ban the user account (e.g., forbid any operation of the user account including login, placing an order, etc.), invite a user of the user account to provide more information (e.g., a face authentication, bind a credit card, etc.), silence the user account (e.g., forbid placing an order while the user may still use the user account to log in), or the like, or any combination thereof.

It should be noted that the above description of the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 500 may be accomplished with one or more additional operations not described and/or without one or more of the operations herein discussed. For example, a determination result regarding whether the user account is the target account type may be stored in a storage device (e.g., the storage device 150, the ROM 230, the RAM 240, the storage 390) of the system 100. As another example, the determination result regarding whether the user account is the target account type may be transmitted to a terminal (e.g., a mobile terminal of the operator) to be displayed on a user interface of the terminal.

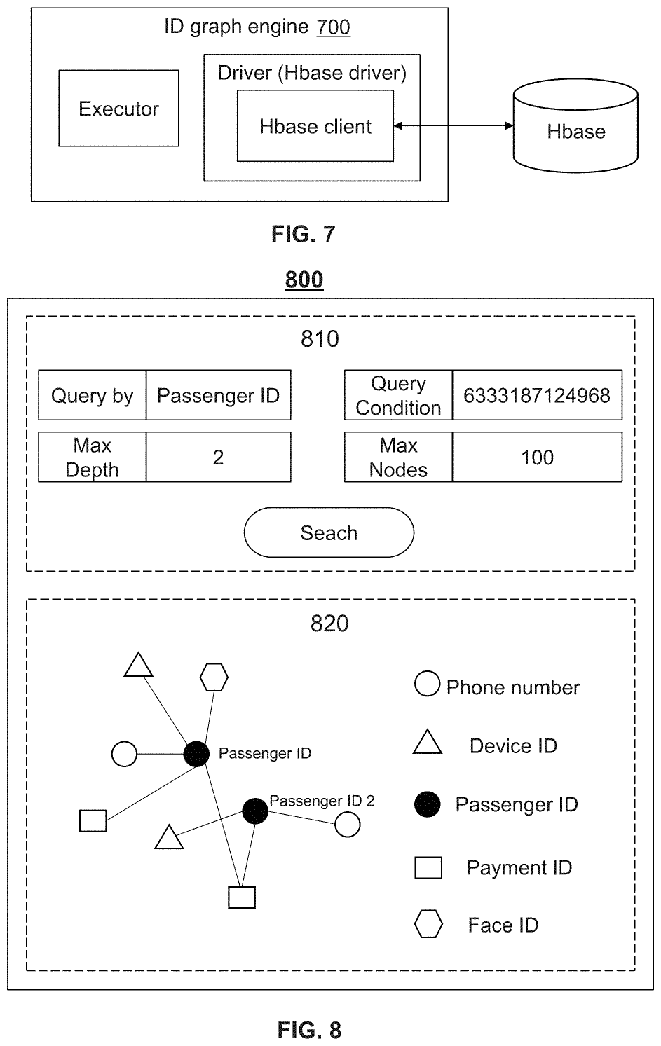

FIG. 6 is a schematic diagram illustrating an exemplary system 600 for generating and accessing an ID graph database according to some embodiments of the present disclosure. As shown in FIG. 6, the system 600 may include a data source layer, a graph engine layer, and a serving layer. In the data source layer, an ELT module may obtain real-time data from a real-time data source and offline data from an offline data source. The real-time data and the offline data may include information of registered user accounts of the system 100. For example, the real-time data and the offline data may include user behaviors of the registered user accounts (e.g., a registration, a login, placing an ordering, canceling an order (e.g., canceling an order after the last finished order or before a finished order), a bubbling event, etc.), user information (e.g., a phone number, a device ID, a credit card ID), or the like, relating to the registered user accounts. The ELT module may process the online data and the offline data to obtain the information of registered user accounts. For example, the ELT module may perform an extracting procedure, a transforming procedure, and a loading procedure on the online data and the offline data. In some embodiments, a data cleansing procedure may be further performed to clean error data caused by data pollutions. The ELT module may transmit the processed data to an ID graph engine. An exemplary ID graph engine may be found elsewhere (e.g., FIG. 7 and the descriptions thereof) in the present disclosure.

In the graph engine layer, the ID graph engine may transform the processed data into the underlying data structure and store the processed data of the underlying data structure in a graph database, thereby generating the ID graph database. For example, the ID graph engine may transform the processed data into an HBase data structure and store the processed data of the HBase data structure into an Hbase to obtain the ID graph database. In some embodiments, the ID graph database may be updated in real time or periodically.

In the serving layer, an ID graph querier may exchange data and information with the graph engine layer (or the ID graph database). For example, the ID graph querier may identify a query associated with a user account A and access the ID graph database via the ID graph engine in response to the query. The ID graph querier may obtain an ID graph relating the user account A from the ID graph database. The ID graph querier may be a microservice device that obtains trigger events for the query from an online data analysis module, a representation service module, and/or an offline data analysis module. In some embodiments, the online data analysis module may generate real-time trigger events such as the bubbling event associated with the user account, the order stream associated with the user account, the registration of the user account, the login of the user account, etc., as described in operation 510. In some embodiments, the representation service module may generate the query request initiated by the operator (e.g., a customer service agent, a data analyst, a developer, etc.) of the system 100 as described in operation 510. For example, the representation service module may obtain an input for requesting the query of the user account from the operator and represent the ID graph of the user account in response to the query. As another example, the representation service module may include a web application with a front end user interface enabling the presentation of the ID graph of the user account. An exemplary user interface enabling the presentation of the ID graph of the user account may be found elsewhere (e.g., FIG. 8 and the descriptions thereof) in the present disclosure. In some embodiments, the offline data analysis module may generate offline trigger events such as performing a query request every the predetermined time interval described in operation 510. In some embodiments, after obtaining the ID graph of the user account from the ID graph database, the ID graph querier may transmit the ID graph to the online data analysis module, the representation service module, and/or the offline data analysis module to be further analyzed.

FIG. 7 is a schematic diagram illustrating an exemplary ID graph engine 700 according to some embodiments of the present disclosure. As shown in FIG. 7, the ID graph engine 700 may exchange information with an Hbase (the ID graph database). The ID graph engine 700 may include a driver (e.g., an Hbase driver) act as a database driver and an executor. The driver may include an Hbase client that is configured to access the Hbase and/or transform information to an underlying data structure of the Hbase. The executor may be configured to execute a driver instruction in parallel, so as to implement the Hbase driver with the Hbase client.

FIG. 8 is a schematic diagram illustrating an exemplary user interface 800 according to some embodiments of the present disclosure. In some embodiments, the user interface 800 may be part of or may communicate with the representation service module described in FIG. 6. As shown in FIG. 8, the user interface 800 may include an operation interface 810 and a display interface 820. The operation interface 810 may include one or more inputting boxes including “Query by,” “Query condition,” “Max depth,” and “Max nodes,” and a search button. The “Query by” box may receive a query type as an input. For example, in a transportation system 100, the query type may include a type of a register ID (e.g., a passenger ID, a driver ID, etc.), a login ID, a payment ID, a background check ID, a face ID, or the like, or any combination thereof. The “Query condition” box may receive a value of the query type as an input. For example, the value of the query type may include a passenger ID “6333187124968.” The value of the query type may represent a user account. The “Max depth” may refer to a maximum count of edges of a displayed ID graph. For example, the “Max depth” box receives “2” as an input. The “Max nodes” may refer to a maximum count of nodes of the displayed ID graph. For example, the “Max nodes” box receives “100” as an input. In some embodiments, the operation interface 810 may further include a timestamp box (not shown) that receives a timestamp value (e.g., “2018-09-06”) as an input. An operator may fill the inputting boxes and click the search button to send a query request to the ID graph querier. The display interface 820 may then display a corresponding ID graph obtained from the ID graph databased via the ID graph querier as shown in FIG. 6. Different IDs may be represented as different shapes. As shown in FIG. 8, the passenger ID (represented as a black solid circle) is connected to a phone number (represented as a black hollow circle), a device ID (represented as a black hollow triangle), a face ID (represented as a black hollow hexagon), and two payment IDs (each represented as a black hollow rectangle). The passenger ID has a common payment ID with a passenger ID 2 (represented as a black solid circle). The passenger ID 2 connects to a different phone number and a different device ID from the passenger ID.

FIG. 9 is a flowchart illustrating an exemplary process 900 for determining whether a user account is a duplicate account according to some embodiments of the present disclosure. In some embodiments, the process 900 may be executed by the system 100. For example, the process 900 may be implemented as a set of instructions (e.g., an application) stored in a storage device (e.g., the storage device 140, the ROM 230, the RAM 240, the storage 390). In some embodiments, the processing device 112 (e.g., the processor 220 of the computing device 200, the CPU 340 of the mobile device 300, and/or one or more modules illustrated in FIG. 4) may execute the set of instructions and may accordingly be directed to perform the process 900.

In 910, the processing device 112 (e.g., the determination module 430, the processing circuits of the processor 220) may determine whether the user account connects to one or more second user accounts via at least one common node based on the ID graph.

As used herein, a common node may refer to a node that connects to two or more user accounts. For example, as shown in FIG. 8, the node of payment ID (represented as a black hollow rectangle) is a common node of the passenger ID and the passenger ID 2. In some embodiments, a common node may reflect the relationships of the two or more user accounts. For example, in some circumstances, a person with two user accounts may register on the system 100 using two different phone numbers, login and/or place an order on the system 100 using two different device IDs, but pay for the system 100 using a same credit card ID. The same credit card ID may be represented as a common node that connects the two user accounts. The determining of whether there are one or more common nodes of user accounts may be helpful to determine whether there are duplicate accounts used by a same person. In some embodiments, the processing device may determine whether the user account connects to a second user account by determining whether the user account and the second user account have at least one common node. For example, if the user account and the second user account have at least one common node, the processing device 112 may determine that the user account connects to the second user account. For example, if the user account and the second user account using a same phone number, a same face ID, a same fingerprint ID, a same e-mail ID, a same device ID, a same credit card ID, a same Paypal ID, a same national ID, or a same Facebook® ID, etc., to communicate with the system 100 (e.g., register, login, pay, or for the background check on the system 100), the same ID(s) may be represented as one or more common nodes. The user account and the second user account may be determined to be connected.

In some embodiments, the processing device 112 may determine whether the user account connects to the second user account based on a count of the at least one common node. For example, if the count of the at least one common node is greater than a count threshold, the processing device 112 may determine that the user account connects to the second user account. Otherwise, the processing device 112 may determine that the user account does not connect to the second user account. In some embodiments, the count threshold may be determined by the system 100 (e.g., according to a machine learning method) or by an operator of the system 100, and stored in a storage device (e.g., the storage device 140, the ROM 230, the RAM 240, the storage 390) of the system 100. In some embodiments, the count threshold may be 1, 2, 3, etc. For example, the count threshold may be 1. As long as the user account and the second account have one common node (e.g., any one of a same register ID, a same login ID, a same payment ID, a same background check ID, or a same face ID), the processing device 112 may determine that the user account connects to the second user account. As another example, the count threshold may be 2. If the user account and the second account have only one common node, the processing device 112 may determine that the user account does not connect to the second user account. Two or more common nodes may be more convincing than only one common node for determining that the user account and the second user account could be a duplicate account for each other. For example, a common node representing a same device ID may be used by two different users due to trading of the device from a first user to a second user. Thus, if two user accounts have only the same device ID as the only one common node, the processing device 112 may determine that the two user accounts are not connected. If the two user accounts have not only the same device ID, but also one or more other same IDs (i.e., the count of the common nodes are not less than 2), the processing device 112 may determine that the user account connects to the second user account. As still another example, if the user account and the second user account have only one certain common node (e.g., a same biometric ID which is difficult to fake, a certain criminal type), even if the count of the at least one common node is less than the count threshold, the processing device 112 may still determine that the user account and the second user account are connected.

In some embodiments, the determination as to whether the user account connects to the second user account may be associated with the confidence weight of each common node of the at least one common node. As described above, the confidence weight of a node may represent a confidence that the node contributes a determination that the user account is the target account type. For example, the processing device 112 may determine a first confidence as a sum or a weighted average value of confidence weight(s) of the at least one node. If the first confidence is greater than (or not less than) a confidence threshold, the processing device 112 may determine that the user account connects to the second user account. Otherwise, the processing device 112 may determine that the user account does not connect to the second user account. In some embodiments, the confidence threshold may be determined by the system 100 (e.g., according to a machine learning method) or by an operator of the system 100, and stored in a storage device (e.g., the storage device 140, the ROM 230, the RAM 240, the storage 390) of the system 100. In some embodiments, the processing device 112 may assign a confidence weight for each node. The confidence weight may be assigned based on an attribute of the node. In some embodiments, the more unique of the node, the greater the confidence weight of the node. For example, a biometric ID (e.g., a face ID, an iris ID, a fingerprint ID, a voice ID, or a signature ID) that is difficult to fake may have a greater confidence weight than any other nodes. In some embodiments, the more important of the node contributes to the target account type, the greater the confidence weight of the node. For example, a certain criminal type (e.g., a murderer, a rapist) may comprise a greater confidence weight than any other nodes. For example, a confidence weight of a device ID may be 0.1, a confidence weight of a phone number may be 0.1, a confidence weight of a face ID may be 0.5, and a confidence weight of a PayPal ID may be 0.3. For example, the confidence threshold is 0.5. In an exemplary circumstance that the user account and the second user account have two common nodes including a same device ID and a same phone number. The processing device 112 may determine that a first confidence (e.g., a sum value of the two confidence weights) of the two common nodes as 0.2 (0.1+0.1). The first confidence is less than the confidence threshold, and the processing device 112 may determine that the user account does not connect to the second user account. As another example, the user account and the second user account have a common node of a same face ID. The first confidence (e.g., a sum value of the confidence weight) of the common node is 0.5, which is not less than the confidence threshold. The processing device 112 may determine that the user account connects to the second user account. As still another example, if the user account and the second user account have only one certain common node (e.g., a same biometric ID which is difficult to fake, a certain criminal type), even if the first confidence of the at least one common node is less than the confidence threshold, the processing device 112 may still determine that the user account and the second user account are connected.

In some embodiments, the processing device 112 may take both the count and the confidence weight(s) of the at least one node into consideration. For example, if the count of the at least one common node is greater than the count threshold, and the weighted average value of the confidence weight(s) of the at least one common node is greater than the confidence threshold, the processing device 112 may determine that the user account connects to the one or more second user accounts. Otherwise, the processing device 112 may determine that the user account does not connect to the second user account.

In 920, in response to a determination that the user account connects to the one or more second user accounts via the at least one common node, the processing device 112 (e.g., the determination module 430, the processing circuits of the processor 220) may determine the user account is a duplicate account of the one or more second user accounts. The user account and the one or more second user accounts may be duplicate accounts of a same user. In response to a determination that the user account does not connect to any second user account, the processing device 112 may determine the user account is not a duplicate account.

In some embodiments, the processing device 112 may determine that the duplicate account belongs to or is used by the same user. In some embodiments, the processing device 112 may automatically combine the user account and the one or more second user accounts into a single user account. In some embodiments, the processing device 112 may inform the user of the duplicate account and ask the user to choose one of the duplicate accounts. Optionally, the processing device 112 may further communicate with the user and ask the user to provide a reason for registering the duplicate accounts.

FIG. 10 is a flowchart illustrating a process 1000 for determining whether a user account is associated with a potential security threat according to some embodiments of the present disclosure. In some embodiments, the process 1000 may be executed by the system 100. For example, the process 1000 may be implemented as a set of instructions (e.g., an application) stored in a storage device (e.g., the storage device 140, the ROM 230, the RAM 240, the storage 390). In some embodiments, the processing device 112 (e.g., the processor 220 of the computing device 200, the CPU 340 of the mobile device 300, and/or one or more modules illustrated in FIG. 4) may execute the set of instructions and may accordingly be directed to perform the process 1000.

In 1010, the processing device 112 (e.g., the determination module 430, the interface circuits of the processor 220) may obtain user behavior record associated with the user account.

In some embodiments, the user behavior record associated with the user account may include any historical user behavior that the user of the user account performed while providing or being provided the service associated with the system 100. In some embodiments, the user behavior record may include behaviors performed through the user account. For example, the user behavior record may include a registration, a login, placing an order, canceling an order, a bubbling event, or the like, or any combination thereof. In some embodiments, the user behavior record may include behaviors of the user when providing or receiving the service but not directly associated with the user account itself. For example, the user behavior record may include record of the user being rude or committing indecent, inappropriate, or even criminal activities when receiving or providing the service.

In 1020, the processing device 112 (e.g., the determination module 430, the interface circuits of the processor 220) may obtain user information associated with the user account.

In some embodiments, the user information associated with the user account may include personal information of the user, such as but not limited to a gender of the user, an age of the user, an occupation of the user, a personal credit score of the user. In some embodiments, the user information may include any information extracted from the user information (e.g., the data mining information relating to the potential security threat). For example, the user information may include the user's public records (e.g., criminal records). Such information may be extracted based on other information or the user, but it is not necessarily associated with receiving or providing the service. In some embodiments, the processing device 112 may obtain the user behavior record and the user information from a storage device (e.g., the storage device 150, the ROM 230, the RAM 240, the disk 270, the storage 390) or an external resource of the system 100.

In 1030, the processing device 112 (e.g., the determination module 430, the processing circuits of the processor 220) may determine whether the user account is associated with the potential security threat based on the ID graph, the user behavior record, and the user information.

In some embodiments, the processing device 112 may preprocess the ID graph, the user behavior record, and the user information. For example, the ID graph, the user behavior record, and the user information may be processed and/or aggregated into an input format of a trained machine learning model. The trained machine learning model may be an algorithm or a process for predicting whether the user account is associated with the potential security threat. In some embodiments, the trained machine learning model may be generated by training a preliminary model using historical information of a plurality of users, and stored in a storage device (e.g., the storage device 150, the ROM 230, the RAM 240, the disk 270, the storage 390) or an external resource of the system 100. The trained machine learning model may be generated using any suitable machine learning model algorithm, such as, a random forest algorithm, an xgboost algorithm, a neural network algorithm, which is not limited in the present disclosure. The trained machine learning model may be tested and/or updated according to any suitable algorithm, which is not limited in the present disclosure.

In some embodiments, the processing device 112 may obtain the trained machine learning model from the storage device and determine whether the user account is associated with the potential security threat based on the trained machine learning model, the ID graph, the user behaviors, and the user information. For example, the processed and/or aggregated data of the ID graph, the user behavior record, and the user information may be input into the trained machine learning model, and the trained machine learning model may output a risk score representing a probability that the user account has the potential security threat. In some embodiments, the processing device 112 may obtain the risk score from the trained machine learning model. The processing device 112 may determine whether the user account is associated with the potential security threat based on the risk score. In some embodiments, the risk score may be a numerical value. The higher the risk score, the higher the probability that the user account has the potential security threat. In some embodiments, the processing device 112 may compare the risk score with a score threshold. A comparison result that the risk score is greater than the score threshold may indicate that the user account is associated with the potential security threat. The score threshold may be determined by the processing device 112 automatically, or determined by the operator artificially according to experience. In some embodiments, the output of the trained machine learning model may be a boolean value result that directly indicates whether the user account is associated with the potential security threat. For example, the boolean value result may include “0” and “1,” wherein “0” represents that the user account is not associated with the potential security threat, and “1” represents the user account is associated with the potential security threat.

In some embodiments, the processing device 112 may determine an account management strategy based on a rule of strategies and the risk score. The account management strategy may be an action that the processing device 112 implements on the user account. For example, the account management strategy may include maintaining the user account without taking any additional actions on the user account, banning the user account (e.g., forbidding any operation of the user account including login, placing an order, blacklist the use account), inviting a user of the user account to provide more information(e.g., a face authentication, bind a credit card, etc.), silencing the user account (e.g., forbid placing an order while the user may still use the user account to log in), or the like, or any combination thereof.

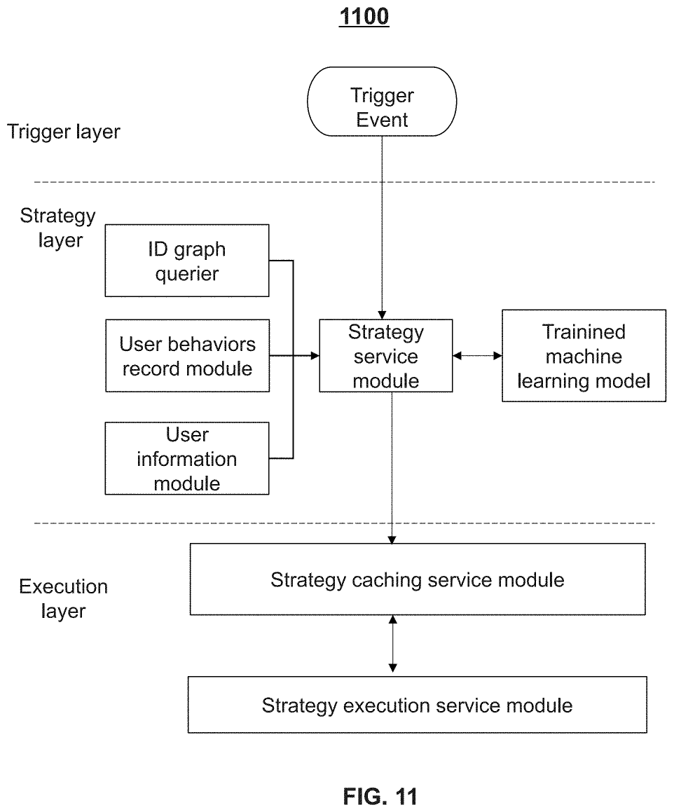

In some embodiments, the rule of strategies may be a process of an algorithm that is used for determining what account management strategy is implemented on the user account based on the risk score and/or the determination result of whether the user account is associated with the potential security threat. In some embodiments, the rule of strategies may be predetermined by the processing device 112 or an operator, and stored in a storage device (e.g., the storage device 150, the ROM 230, the RAM 240, the disk 270, the storage 390) or an external resource of the system 100. For example, the rule of strategies may be a table including a plurality of reference risk scores and a reference account management strategy corresponding to each of the plurality of reference risk scores. The processing device 112 may map the risk score with one of the plurality of reference risk scores, and designate the reference account management strategy corresponding to the reference risk score as the account management strategy. In some embodiments, the processing device 112 may implement the account management strategy on the user account. For example, if the user account is associated with the potential security threat, the processing device 112 may ban the user account by forbidding any operation of the user account including login, placing an order, etc. An exemplary system for determining whether a user account is associated with a potential security threat based on a trained machine learning model, an ID graph, user behaviors, and user information may be found elsewhere (e.g., FIG. 11 and the descriptions thereof) in the present disclosure. In some embodiments, the account management strategy may be effective within a certain time period, for example, within 30 minutes, 1 hour, 1.5 hours after an occurrence of the trigger event. Alternatively, the account management strategy may be permanent.

In some embodiments, after determining that the user account is associated with the potential security threat, the processing device 112 may further identify a third user account that is also associated with the potential security threat. For example, the processing device 112 may determine the third user that is connected with the user account within a hoop threshold in the ID graph. As used herein, a hoop may include two nodes connected by one edge. For example, two user accounts sharing one device ID may be considered as the two user accounts are connected in one hoop. The hoop threshold may be determined by the processing device 112 automatically or by the operator artificially according to experience. For example, the hoop threshold may include one hoop, two hoops, etc. If the third user account is connected with the user account within the hoop threshold, the processing device 112 may determine that the third user account is also associated with the potential security threat. The processing device 112 may further implement a second account management strategy (same or different from the account management strategy implemented on the user account) on the third user account. For example, the account management strategy implemented on the user account is silencing the user account and the second account management strategy implemented on the third user account is inviting a user of the third user account to face recognition.

It should be noted that the above description of the process 1000 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the operations of the process 1000 are intended to be illustrative. The process 1000 may be accomplished with one or more additional operations not described and/or without one or more of the operations herein discussed. Additionally, the order in which the operations of the process 1000 described above is not intended to be limiting. For example, operations 1010 and 1020 may be performed simultaneously, or the operation 1020 may be performed before the operation 1010.

FIG. 11 is a schematic diagram illustrating an exemplary system 1100 for determining whether a user account is associated with a potential security threat based on a trained machine learning model, an ID graph, user behaviors, and user information according to some embodiments of the present disclosure. As shown in FIG. 11, the system 1100 may include a trigger layer, a strategy layer, and an execution layer. In the trigger layer, a trigger event may be identified to trigger a query associated with the user account as described 510. The query may be transmitted to a strategy service module. In the strategy layer, the strategy service module may obtain the ID graph associated with the user account from the ID graph querier, user behavior record from a user behavior record module (e.g., a Customer Relationship Management (CRM) service), and user information from the user information module. The strategy service module may process (e.g., perform a data aggregation on) the ID graph, the user behavior record, and the user information to generate strategy data, and transmit the strategy data to a trained machine learning model. The strategy data may be inputs of the trained machine learning model, and the strategy service module may obtain a risk score from the trained machine learning model as an output. The strategy service module may transmit the risk score to an strategy caching service module. In the execution layer, the strategy caching service module may determine an account management strategy that is implemented on the user account based on a rule of strategies and the risk score. A strategy execution service module may obtain the account management strategy and implement the account management strategy on the user account.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. A system, comprising:
at least one storage medium including a set of instruction; and
at least one processor in communication with the storage medium, wherein when executing the set of instructions, the at least one processor is directed to cause the system to perform operations including:
identifying a query associated with a user account;
accessing, by a database driver, an ID graph database to obtain an ID graph relating to the user account; and
determining whether the user account is a target account type based at least on the ID graph, wherein
the ID graph includes a plurality of nodes and a plurality of edges, each of the plurality of edges connecting two nodes,
each of the plurality of nodes includes at least one of a register ID, a login ID, a payment ID, a background check ID, or a face ID, and
each edge that connects two nodes includes at least one of a user type associated with the two nodes, a timestamp when the edge is connected, or source information of the edge.

2. The system of claim 1, wherein the query is triggered by a bubbling event associated with the user account, an order stream associated with the user account, a registration of the user account, a login of the user account, or a query request initiated by an operator.

3. The system of claim 1, wherein the ID graph database includes an Hbase.

4. The system of claim 1, wherein the target account type is a duplicate account, and the determining whether the user account is the target account type based at least on the ID graph includes:
determining whether the user account connects to one or more second user accounts via at least one common node based on the ID graph; and
in response to a determination that the user account connects to the one or more second user accounts via the at least one common node, determining the user account is the duplicate account of the one or more second user accounts.

5. The system of claim 1, wherein the target account type is associated with a potential security threat, and the determining whether the user account is the target account type based at least on the ID graph includes:
obtaining user behavior record associated with the user account;
obtaining user information associated with the user account; and
determining whether the user account is associated with the potential security threat based on the ID graph, the user behavior record, and the user information.

6. The system of claim 5, wherein the determining whether the user account is associated with the potential security threat based on the ID graph, the behavior record, and the user information includes:
obtaining a trained machine learning model; and
determining whether the user account is associated with the potential security threat based on the trained machine learning model, the ID graph, the user behavior record, and the user information.

7. The system of claim 6, wherein the determining whether the user account is associated with the potential security threat based on the trained machine learning model, the ID graph, the user behavior record, and the user information includes:
obtaining a risk score representing a probability that the user account has the potential security threat by inputting the ID graph, the user behavior record, and the user information into the trained machine learning model, wherein the risk score is an output of the trained machine learning model; and
determining whether the user account is associated with the potential security threat based on the risk score, wherein the risk score being greater than a score threshold indicates that the user account is associated with the potential security threat.

8. The system of claim 7, further comprising:
determining an account management strategy based on a rule of strategies and the risk score; and
implementing the account management strategy on the user account, wherein the strategy includes at least one of maintaining the user account, banning the user account, inviting a user of the user account to provide more information, or silencing the user account.

9. The system of claim 7, further comprising:
identifying a third user account connected with the user account within a hoop threshold; and
determining that the third user account is associated with the potential security threat.

10. The system of claim 1, wherein each of the plurality of nodes of the ID graph comprises a confidence weight representing a confidence that the node contributes a determination that the user account is the target account type.

11. The system of claim 10, wherein different nodes representing different IDs comprise different confidence weights, and the node of the face ID comprises a greater confidence weight than any other nodes.

12. A method, comprising:
identifying a query associated with a user account;
accessing, by a database driver, an ID graph database to obtain an ID graph relating to the user account; and
determining whether the user account is a target account type based at least on the ID graph, wherein
the ID graph includes a plurality of nodes and a plurality of edges, each of the plurality of edges connecting two nodes,
each of the plurality of nodes includes at least one of a register ID, a login ID, a payment ID, a background check ID, or a face ID, and
each edge that connects two nodes includes at least one of a user type associated with the two nodes, a timestamp when the edge is connected, or source information of the edge.

13. The method of claim 12, wherein the query is triggered by a bubbling event associated with the user account, an order stream associated with the user account, a registration of the user account, a login of the user account, or a query request initiated by an operator.

14. The method of claim 12, wherein the ID graph database includes an Hbase.

15. The method of claim 12, wherein the target account type is a duplicate account, and the determining whether the user account is the target account type based at least on the ID graph includes:
determining whether the user account connects to one or more second user accounts via at least one common node based on the ID graph; and
in response to a determination that the user account connects to the one or more second user accounts via the at least one common node, determining the user account is the duplicate account of the one or more second user accounts.

16. The method of claim 12, wherein the target account type is associated with a potential security threat, and the determining whether the user account is the target account type based at least on the ID graph includes:
obtaining user behavior record associated with the user account;
obtaining user information associated with the user account; and
determining whether the user account is associated with the potential security threat based on the ID graph, the user behavior record, and the user information.

17. The method of claim 16, wherein the determining whether the user account is associated with the potential security threat based on the ID graph, the behavior record, and the user information includes:
obtaining a trained machine learning model; and
determining whether the user account is associated with the potential security threat based on the trained machine learning model, the ID graph, the user behavior record, and the user information.

18. The method of claim 17, wherein the determining whether the user account is associated with the potential security threat based on the trained machine learning model, the ID graph, the user behavior record, and the user information includes:
obtaining a risk score representing a probability that the user account has the potential security threat by inputting the ID graph, the user behavior record, and the user information into the trained machine learning model, wherein the risk score is an output of the trained machine learning model; and
determining whether the user account is associated with the potential security threat based on the risk score, wherein the risk score being greater than a score threshold indicates that the user account is associated with the potential security threat.

19. The method of claim 12, wherein each of the plurality of nodes of the ID graph comprises a confidence weight representing a confidence that the node contributes a determination that the user account is the target account type.

20. A non-transitory computer readable medium, comprising at least one set of instructions, when accessed by at least one processor of a system for improving security, causes the system to execute a method, the method comprising:
identifying a query associated with a user account;
accessing, by a database driver, an ID graph database to obtain an ID graph relating to the user account; and
determining whether the user account is a target account type based at least on the ID graph, wherein
the ID graph includes a plurality of nodes and a plurality of edges, each of the plurality of edges connecting two nodes,
each of the plurality of nodes includes at least one of a register ID, a login ID, a payment ID, a background check ID, or a face ID, and
each edge that connects two nodes includes at least one of a user type associated with the two nodes, a timestamp when the edge is connected, or source information of the edge.
